(19) United States
(12) Patent Application Publication
(10) Pub. No.: US 2016/0091093 A1
(43) Pub. Date: Mar. 31, 2016

(54) JOINTED GASKET

(71) Applicant: Saint-Gobain Performance Plastics Corporation, Aurora, OH (US)

(72) Inventors: Kyungho LEE, lncheon (KR); Hongju SON, Seoul (KR)

(21) Appl. No.: 14/869,228

(22) Filed: Sep. 29, 2015

Related U.S. Application Data
(60) Provisional application No. 62/056,713, filed on Sep. 29, 2014.

(51) Int. Cl. F16J 15/10; B32B 7/06; F16J 15/06; B32B 5/18

(52) U.S. Cl. CPC F16J 15/104; B32B 5/18; B32B 7/06; F16J 15/061; F16J 15/102; B32B 2266/0207; B32B 2266/0235; B32B 2266/0278; B32B 2266/0292; B32B 2307/748; B32B 2405/00; B32B 2581/00

(57) ABSTRACT

The present disclosure is directed to continuous gaskets, and particularly to continuous gaskets having at least one joint. Embodiments include continuously jointed gaskets exhibiting exceptional sealing performance against dust and water comparable to seamless molded gaskets. Other embodiments of the disclosure are directed to continuous gaskets having at least one bend groove adapted to form a desired bending angle. The bend groove can have a particular profile that enhances the bent characteristics.

### CROSS-REFERENCE TO RELATED APPLICATION(S)

This application claims priority under 35 U.S.C. §119(e) to U.S. Provisional Patent Application No. 62/056,713 entitled, “JOINTED GASKET,” by Kyungho Lee et al., filed Sep. 29, 2014. Each patent application cited herein is hereby incorporated by reference in its entirety.

### FIELD OF THE DISCLOSURE

The present disclosure relates to gasket materials and more particularly to, jointed gasket materials.

### RELATED ART

Traditionally, continuous gasket materials have been produced by molding to achieve the desired conformability to the particular casing and the necessary sealing performance. However, as gasket materials have increased in size, molding methods for such gasket materials has become uneconomical.

Accordingly, a need exists to provide improved gasket constructions and methods of gasket manufacturing that solve these and other problems.

### BRIEF DESCRIPTION OF THE DRAWINGS

Embodiments are illustrated by way of example and are not limited in the accompanying figures.

FIG. 1 includes an illustration of a top view of a continuous jointed gasket according to an embodiment.

FIG. 2 includes an illustration of a perspective view of a gasket material according to an embodiment.

FIG. 3 includes an illustration of a cross section view of a gasket material according to an embodiment.

FIG. 4 includes an illustration of a close up view of a butt joint in a jointed gasket according to an embodiment.

FIG. 5 includes an illustration of a close up view of a puzzle joint in a jointed gasket according to an embodiment.

FIG. 6 includes an illustration of an exploded view of a butt joint in a jointed gasket according to an embodiment.

FIG. 7a includes an illustration of a top view of a bend groove in the open or undeformed position according to an embodiment.

FIG. 7b includes an illustration of a top view of a bend groove in the closed or deformed position according to an embodiment.

FIG. 8 includes an illustration of a top view of an asymmetrical bend groove in the open position according to an embodiment.

FIG. 9 includes an illustration of a gasketed assembly according to an embodiment.

FIG. 10 includes an illustration of a splice mold and splice molding operation according to an embodiment.

FIGS. 11-14 include illustrations of various sample constructions used in Example 1.

FIG. 15 includes an illustration of a test setup for determining dust and water tight performance.

FIGS. 16-17 include illustrations of various sample constructions used in Example 2.

FIGS. 18-19 include illustrations of various sample constructions used in Example 3.

FIGS. 20-22 include photographs of sample and testing apparatus constructions used in Example 4.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the gasket arts.

A first aspect of the present disclosure is directed to a jointed gasket. The present inventors surprisingly discovered a jointed gasket that can exhibit exceptional sealing performance. The concepts are better understood in view of the embodiments described below that illustrate and do not limit the scope of the present invention.

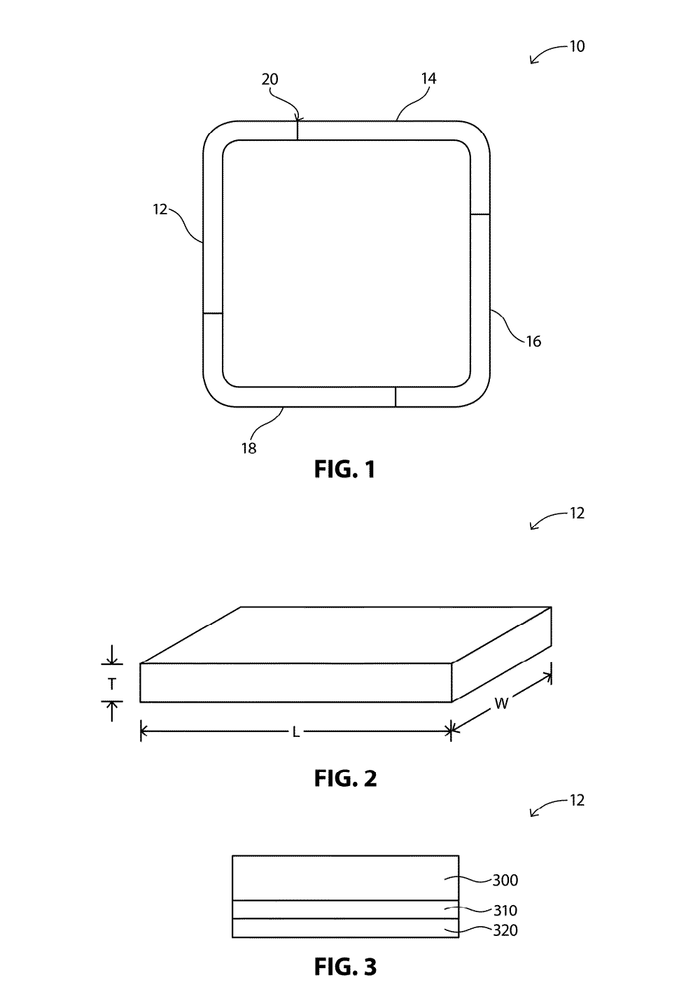

Referring now to FIG. 1, there is illustrated a continuous jointed gasket 10 according to certain embodiments. As illustrated in FIG. 1, the continuous jointed gasket 10 can include one or more gasket material strips 12, 14, 16, 18 coupled together at a joint 20.

The continuous jointed gasket 10 can include any number of desired gasket material strips, depending in part, on the circumference of the continuous jointed gasket 10 and the length of the individual gasket material strips. For example, a continuous jointed gasket can include at least 1, at least 2, at least 3, or even at least 4 gasket material strips. In further embodiments, a continuous jointed gasket can include no more than 20 gasket material strips, no more than 15 gasket material strips, no more than 10 gasket material strips, or even no more than 5 gasket material strips. In still further embodiments, a continuous jointed gasket can include a number of gasket material strips in a range of any of the minimum and maximums provided above, such as in a range of 1-20 gasket material strips, or even 2-10 gasket material strips.

The continuous jointed gasket 10 can have a desired circumference, depending in part on the desired application. In particular embodiments, the continuous jointed gasket 10 can have a large circumference. For example, in particular embodiments, the continuous jointed gasket 10 can have a circumference of at least 0.5 meters, at least 1 meter, at least 1.5 meters, or even at least 2 meters. In further embodiments, the continuous jointed gasket 10 can have a circumference of no greater than 50 meters, no greater than 20 meters, or even no greater than 5 meters. In still further embodiments, the continuous jointed gasket 10 can have a circumference in a range of any of the minimum and maximum values provided above, such as in a range of from 0.5 meters to 50 meters or even 2 meters to 20 meters.

A particular advantage of certain embodiments of the present disclosure is the ability to efficiently and effectively form a continuous jointed gasket 10 having a large circumference. Prior gaskets and gasket forming technology relying on molding faced challenges in the ability to economically accommodate continuous gaskets having a large circumference. Further, attempts to create a jointed continuous gasket having a large circumference suffered from the ability to effectively seal against water and dust. Surprisingly, embodiments of the present disclosure were able to form a continuous jointed gasket that provided effective sealing properties and could be economically produced.

As discussed above, the continuous jointed gasket 10 can be formed from one or more gasket material strips 12, 14, 16, 18.

Referring to FIG. 2, which illustrates a perspective view of one embodiment of a gasket material strip 12, the gasket material strip 12 can have a length L, a width W, and a thickness T. For example, in certain embodiments, the length L of the gasket material strips can be greater than the width W, and the width W can be greater than the thickness T. In particular embodiments, the gasket material strips can have a particular ratio of the gasket material strip length L to the gasket material strip width W. For example, in very particular embodiments, the gasket material strips can have a ratio of gasket material strip length L to width W of at least 10:1. Furthermore, in very particular embodiments, the gasket material strip can have a ratio of gasket material strip length L to width W of no greater than 1000:1.

In further embodiments, the gasket material strips can have a particular ratio of the gasket material strip width W to the gasket material strip thickness T. For example, in very particular embodiments, the gasket material strips can have a ratio of gasket material strip width W to thickness T of at least 50:1.

In particular embodiments, the gasket material strips can have an average thickness T of at least about 0.1 mm, at least about 0.3 mm, at least about 0.7 mm, or even at least about 1 mm. In further embodiments, the gasket material strips can have an average thickness T of no greater than about 100 mm, no greater than about 75 mm, no greater than about 50 mm, no greater than about 25 mm, or even no greater than about 10 mm. Moreover, in certain embodiments, the gasket material strips can have an average thickness T in a range of any of the minimums and maximums provided above, such as in a range of from about 0.1 mm to about 100 mm, or even about 1 mm to about 25 mm.

Referring now to FIG. 3, which illustrates a cross-section of a gasket material 12 according to certain embodiments, the gasket material 12 can have a composite structure that can include a sealing layer 300, an adhesive layer 310 and a release layer 320. It is to be understood that the gasket material 12 illustrated in FIG. 3 is only one example a gasket material within the scope of the various embodiments of the present disclosure. More, less, or different layers can be included depending in part on the desired application.

In particular embodiments, the sealing layer 300 can include a compressible layer, such as a foam layer or porous layer. For example, suitable compressible layers can include PVC, EPDM, epoxy, polyurethane, silicone, thermoplastic elastomers or combinations thereof. In more particular embodiments, the sealing layer 300 can include a polyurethane, such as DYNAFOAM® 7440FC (available from Saint-Gobain Performance Plastics Corporation, Granville, N.Y., USA) or a thermoplastic elastomer, such as NORPRENE® P3369 (available from Saint-Gobain Performance Plastics Corporation, Granville, N.Y., USA). In even more particular embodiments, the sealing layer 300 can include a silicone foam.

In particular embodiments, the sealing layer 300 can have an average thickness of at least about 0.1 mm, at least about 0.3 mm, at least about 0.7 mm, or even at least about 1 mm. In further embodiments, the sealing layer 300 can have an average thickness of no greater than about 100 mm, no greater than about 75 mm, no greater than about 50 mm, no greater than about 25 mm, or even no greater than about 10 mm. Moreover, in certain embodiments, the sealing layer 300 can have an average thickness in a range of any of the minimums and maximums provided above, such as in a range of from about 0.1 mm to about 100 mm, or even about 1 mm to about 25 mm.

Referring again to FIG. 3, in certain embodiments, the adhesive layer 310 can be disposed between the release layer 320 and the sealing layer 300. The adhesive layer 310 can include any desired adhesive composition, adhesive tape, composite adhesive tape, or combinations thereof. In particular embodiments, the adhesive layer 310 can include a double-sided adhesive tape.

The release layer 320 can include, for example, a release coating, a release sheet, or combinations thereof. In particular embodiments, the release layer 320 can include a release sheet. The release sheet can be adapted to be peeled or otherwise removed from the gasket material before installation of the gasket. In this way, the adhesive layer would be exposed and can be adhered to a frame element during installation.

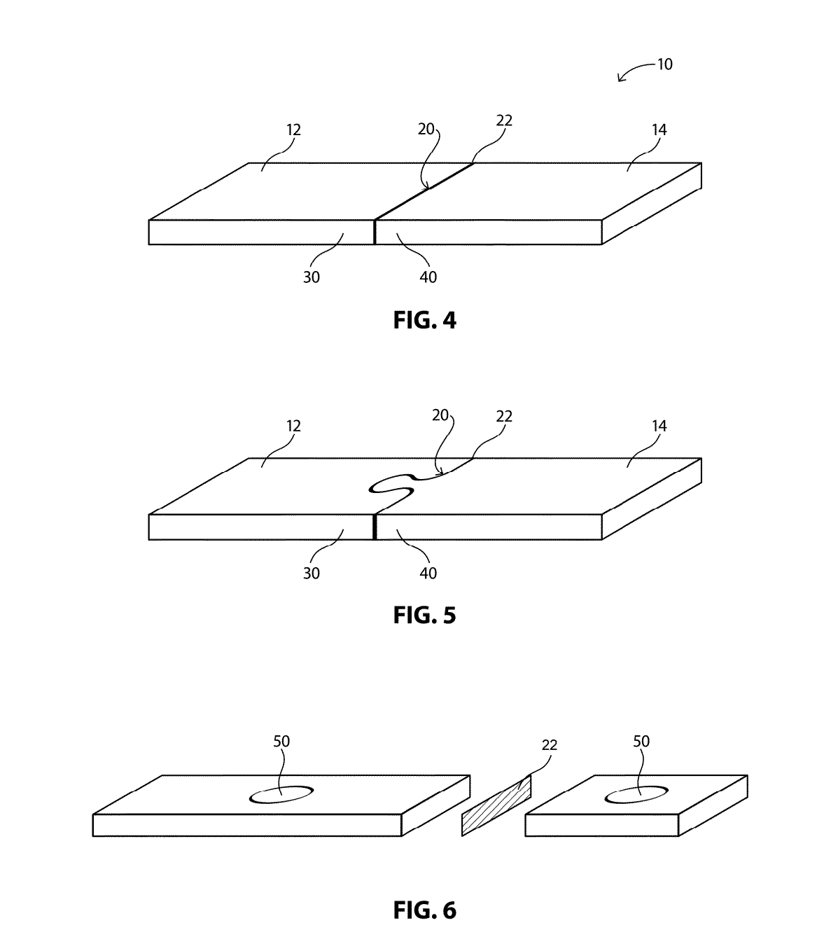

Referring now to FIGS. 4-6, the continuous jointed gasket 10 can include at least one joint 20 coupling together a first end 30 and a second end 40 of a gasket material strip 10. In certain embodiments, such as when only one joint is present in a continuous jointed gasket 10, the first end 30 and the second end 40 can be on opposing ends of a single gasket material strip 12. In other embodiments, when more than one joint is present in a continuous jointed gasket 10, the first end 30 can be disposed on a first gasket material strip 12, and the second end 40 can be disposed on a second gasket material strip 14.

The continuous jointed gasket 10 can include any desired number of joints, and can be influenced by, for example, the desired circumference of the continuous jointed gasket. For example, in particular embodiments, the continuous jointed gasket 10 can include at least 1, at least 2, at least 3, or even at least 4 joints. In further embodiments, the continuous jointed gasket 10 can include no more than 20 joints, no more than 15 joints, no more than 10 joints, or even no more than 5 joints. In still further embodiments, the continuous jointed gasket 10 can include a number of joints in a range of any of the minimum and maximums provided above, such as in a range of 1-20 joints, or even 2-10 joints.

In certain embodiments, the first end 30 and the second end 40 can have a complementary shape such that an intimate connection can be made between the first and second ends 30, 40 at the joint 20. For example, in particular embodiments, the first end 30 and the second end 40 can have complementary butt shapes as illustrated in FIG. 4, complementary puzzle shapes as illustrated in FIG. 5, or combinations thereof. In very particular embodiments, the first end 30 and the second end 40 can have complementary puzzle shapes.

In certain embodiments, the first end 30 and the second end 40 can include an adhesive therebetween to aid in forming the joint, also referred to herein as joint adhesive 22.

In particular embodiments, the joint adhesive 22 can include a silicone adhesive, a urethane adhesive, an epoxy adhesive, an acrylic adhesive, a rubber adhesive, a polyamide adhesive, an EVA adhesive, or combinations thereof. In very particular embodiments, the joint adhesive can include a silicone adhesive.

In particular embodiments, depending in part on the intended application, a suitable joint adhesive 22 can be described by its flammability. For example, in certain applications, such as when used as a gasket for an electric car battery case, it is desired for the gasket to have a low flammability. Accordingly, in certain embodiments, the joint adhesive 22 can include an adhesive having a flammability of at least HB, or even at least V0 as measured according to UL-94. Non-limiting, examples of suitable joint adhesives 22 having a flammability of V0 as measured according to UL-94 (flammability testing for plastics) include silicon adhesives such as LSR (Liquid Silicone Rubber), and ELASTOSIL N 9132′ available from WACKER.

Moreover, it is to be understood that all of the components in the gasket and thus the gasket as a whole can have a desirable flammability, or flame resistance. In particular, any or even all of the components in the gasket and the gasket as a whole can have a flammability rating of at least HB, or even at least V0 as measured according to UL-94.

Furthermore, in certain embodiments, the joint adhesive 22 can be a thermosetting adhesive. A thermosetting joint adhesive 22 can be advantageous in applications where the gasket material may be in a high temperature environment. Non-limiting examples of suitable thermosetting joint adhesives include silicon adhesives such as ELASTOSIL LR 3003/60 available from WACKER.

In other embodiments, the joint adhesive 22 can be a thermoplastic adhesive, particularly a thermoplastic adhesive that meets the flammability characteristics described above. For example, suitable thermoplastic adhesives can include a polyamide adhesive such as Macromelt® 6211, available from Henkel, which has a flammability rating of at least HB, or even at least V0 as measured according to UL-94.

Referring in particular to FIG. 6, which illustrates a perspective exploded view of a jointed section of a jointed gasket, in certain embodiments, the gasket material can include at least one alignment structure 50. The alignment structure 50 can have any desired shape. For example, the alignment structure 50 can have a shape which is adapted to engage with a complementary alignment structure disposed on a frame for installation. As illustrated in FIG. 6, the alignment structure 50 can be an aperture or cut-out from the gasket material, and the frame to which to gasket material is to be installed, can have a complementary protrusion (not shown) that can engage with the aperture to locate the gasket in a predetermined location on the frame.

In addition to the alignment structure's function of aligning the gasket material in a predetermined location and shape within a frame, the alignment structures can be further adapted to align a first end and a second end of a gasket material for joining in a splice mold as will be discussed in more detail below.

Another aspect of the present disclosure is directed to a gasket material strip adapted to form bends in a continuous jointed gasket without sacrificing sealing performance. Traditionally, bends were formed by cutting out a V-shaped groove from the gasket material. However, such V-shaped grooves create unevenness in the gasket material strip when bent and reduce the sealing capability of the gasket.

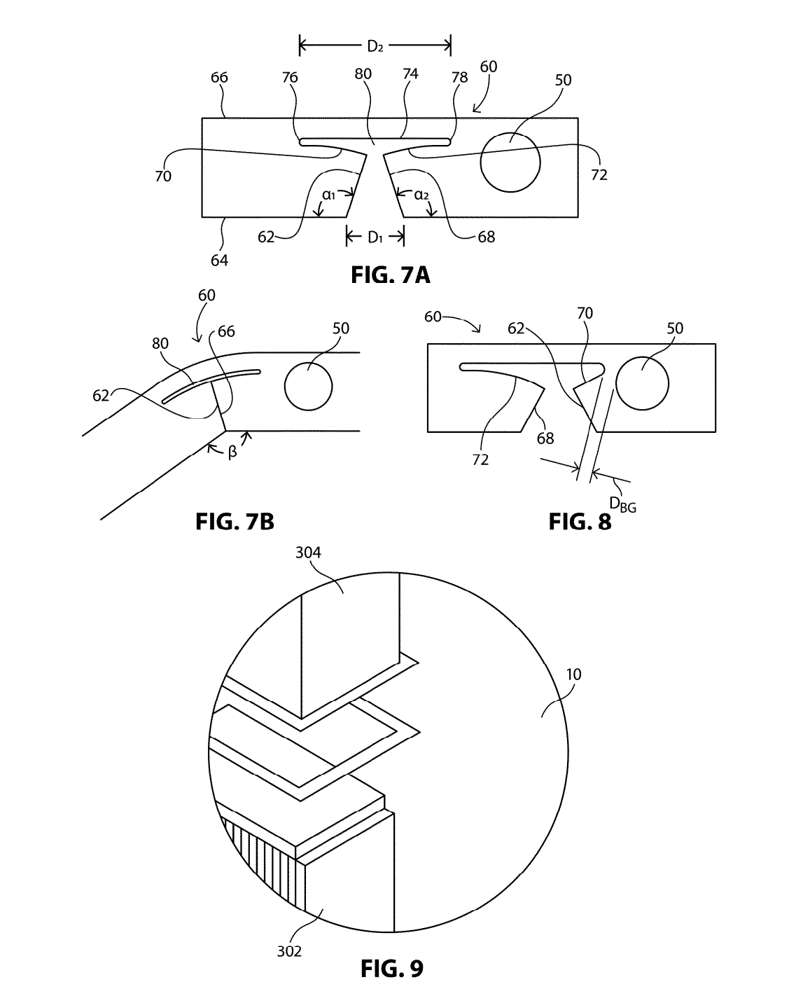

Referring now to FIGS. 7a and 7b, which illustrates an undeformed or open bend and a deformed or a closed bend respectively, a gasket material strip 12 can include one more bend grooves 60. The bend grooves 60 can be grooves cut out of the gasket material strip 12 at the desired bend location.

The bend groove 60 can have a particular shape or profile. For example, FIG. 7a illustrates one embodiment of a suitable bend groove shape or profile in the open or undeformed state. As illustrated, the bend groove 60 can have a first surface 62 extending from a first edge 64 of the gasket material strip 12 towards the opposite edge 66 of the gasket material strip 12 at an angle of α₁. The angle α₁ can be selected based on the desired bend angle β of the gasket when installed.

The bend groove 60 can further have a second surface 68 extending from the first edge 64 of the gasket strip material 12 towards the opposite edge 66 of the gasket material strip at an angle α₂. Again, the angle α₂ can be selected based on the desired bend angle β of the gasket when installed.

The first surface 62 and second surface 68 of the bend groove 60 can be generally spaced apart from one another a distance D₁, as measured from the intersecting point of the first surface 62 and the first edge 64 to the intersecting point of the second surface 68 and the first edge 64. Further, the first surface 62 and second surface 68 can generally extend toward each other as the surface extends from the first edge 64 of the gasket material strip towards the opposite edge 66 of the gasket material strip. The first surface 62 and the second surface 68 can be adapted to abut when the gasket material strip is bent to the desired shape such that the predetermined bending angle can be achieved.

The bend groove can further include a third surface 70 extending from the end of the first surface 62 and away from the second surface 68.

The third surface 70 can have an arcuate profile.

The bend groove 60 can further include a fourth surface 72 extending from the end of the second surface 68 and away from the first surface 62.

The fourth surface 72 can have an arcuate shape.

In certain embodiments, the third surface 70 and the fourth surface 72 can be generally symmetrical.

The bend groove 60 can further include a fifth surface 74 extending between and connecting the third surface 70 and the fourth surface 72 by a distance of D₂. The fifth surface 74 can extend generally parallel to the outer edge 66 of the gasket strip material.

The bend groove 60 can further include a first chamfer 76 and a second chamfer 78. The first chamfer can be disposed between the third surface 70 and the fifth surface 74 and the second chamfer 78 can be disposed between the fourth surface 72 and the fifth surface 74.

The first chamfer 76 and the second chamfer 78 can be adapted to form an open buffer space 80 through the gasket material after bent. For example, when the gasket material strip is bent to the predetermined bending angle during the continuous jointed gasket formation and the first and second surfaces 62, 66 abut, the buffer space 80 can be open to allow for inconsistencies in the frame, gasket material strip, or bend groove formation.

The length of the buffer space between the third surface 70 and the fifth surface 74 and between the fourth surface 72 and the fifth surface 74 can be at least about 0.1 mm, at least about 0.5 mm, or even at least about 1 mm. In further embodiments, length of the buffer space between the third surface 70 and the fifth surface 74 and between the fourth surface 72 and the fifth surface 74 can be no greater than 20 mm, no greater than 15 mm, or even no greater than 10 mm. In still further embodiments, length of the buffer space between the third surface 70 and the fifth surface 74 and between the fourth surface 72 and the fifth surface 74 can be in a range of any of the minimum and maximum values provided above, such as in a range of 0.1 mm to 20 mm, or even 1 mm to 10 mm. It is to be understood that the length of the buffer space between the third surface and the fifth surface and between the fourth surface and the fifth surface can be selected as desired depending on the particular application and constraints of the sealing system.

The distance from the end of the third surface 70 to the edge 66 of the gasket strip material can be at least 1 mm, at least 2 mm, at least 3 mm, at least 4 mm, or even at least 5 mm. In further embodiments, the distance from the end of the third surface 70 to the edge 66 of the gasket strip material can be no greater than 25 mm, no greater than 20 mm, no greater than 15 mm, or even no greater than 10 mm. In still further embodiments, the distance from the end of the third surface 70 to the edge 66 of the gasket strip material can be in a range of the minimum and maximum values provided above, such as in a range of from 1 mm to 25 mm, or even 4 mm to 10 mm. In particular embodiments, such a spacing has been discovered to provide the desirable sealing effect while simultaneously providing sufficient strength to the gasket material to avoid damage during handling and installation of the gasket material. Further, the buffer space as a whole can be advantageous to provide some flexibility and tolerance to adapt to tolerances of the frame assembly to which the gasket is to be installed.

As on overall description of the bend groove profile shape, in the particular embodiment illustrated in FIGS. 7a and 7b, the bend groove 60 can be described as having have a generally “T” shaped profile.

In certain embodiments, the first surface 62 and second surfaces 68 can be generally symmetrical such that α₁ and α₂ are within about 10 degrees of each other.

In other embodiments, α₁ and α₂ can be within about 70 degrees of each other, within about 60 degrees of each other, or even within about 50 degrees of each other.

In further embodiments, as particularly illustrated in FIG. 8 the bend groove 60 can be asymmetrical. For example, it particular embodiments, such as when the bend groove 60 is near an alignment structure 50, the bend groove 60 can have an asymmetrical profile. In very particular embodiments, the asymmetrical bend groove can have the third surface 70 having a shorter distance than the fourth surface 72, the third surface 70 being nearer the alignment structure 50 than the fourth surface 72. In particular embodiments, the bend groove 60 can have a shortest distance D_{BG} from the alignment structure of at least about 2 mm, or even at least about 3 mm. Furthermore, in particular embodiments, the asymmetrical bend groove 60 can have a shortest distance from the alignment structure of no greater than 10 mm, no greater than 8 mm, or even no greater than 6 mm.

A particular advantage of embodiments of the asymmetrical bend groove of the present disclosure is the ability to get very close to the alignment structure without sacrificing sealing performance and maintaining structural integrity.

Another aspect of the present disclosure is directed to a gasketed assembly. Referring to FIG. 9, one embodiment of gasketed assembly 300 can include a housing 302, a lid 304, and a continuous jointed gasket 10 as described above.

In very particular embodiments, the gasketed assembly can include a battery case assembly, such as an electric vehicle battery case.

Another aspect of the present disclosure is directed to a method of forming a gasket material, and in particular, a method of forming a plurality of gasket material strips from a roll of gasket sheet material. A method of forming a gasket material can generally include:
a. providing a gasket sheet material;
b. forming a plurality of gasket material strips from the gasket material sheet,
c. forming complementary profiles on the first end and the second end of the gasket material strips;
d. applying an adhesive to the first and/or second end of the gasket material strips; and
e. joining the first end to the second end to form a jointed gasket.

In certain embodiments, the step of providing a gasket sheet material can include forming a gasket sheet material. For example, the gasket sheet material can be formed by casting, extrusion, or any combination thereof. In particular embodiments, the gasket sheet material can be formed by continuous processes, such as casting. A particular advantage of certain embodiments of the present disclosure is the ability to form a continuous gasket from a gasket sheet material as opposed to molding a continuous gasket in a batch process.

In certain embodiments, the gasket sheet material can be in the form of a roll of gasket sheet material. In particular embodiments, the roll of gasket material can have an unwound length of at least about 1 meter. In further embodiments, the roll of gasket material can have an unwound length of no greater than about 50 meters. In still further embodiments, the roll of gasket material can have an unwound length in a range of any of the minimum and maximum values provided above, such as in a range of from 10 meters to 30 meters.

The roll of gasket material can have a width of at least about 3 mm. In further embodiments, the roll of gasket material can have a width of no greater than about 200 mm. In still further embodiments, the roll of gasket material can have a width in a range of any of the minimum and maximum values provided above, such as in a range of from 5 mm to 200 mm.

As discussed above, the method can include forming a plurality of gasket material strips from the gasket sheet material. For example, the gasket material strips can be formed by cutting, such as die cutting, laser cutting, punching, or any other suitable process for forming an appropriately dimensioned gasket material strip from a sheet of gasket material.

As also discussed above, the method can include forming complementary profiles on the first end and the end of the gasket material strips. For example, as discussed within this document, the first end of a gasket material strip and a second end of a gasket material strip can be adapted to be coupled together to form a jointed gasket. Accordingly, the method can include forming complementary engagement profiles on the each end of the gasket material strip to form a secure and continuous connection.

In particular embodiments, the complementary profiles can be formed by cutting, such as die cutting, laser cutting, punching, or any other suitable process for forming the complementary profiles on a gasket material strip. It is to be understood that the method can include any of the profiles discussed herein, such as butt profiles, puzzle profiles, or combinations thereof.

The method can further include applying an adhesive to the first and/or second end of the gasket material strips. For example, as discussed herein, the adhesive can be applied to one or both ends of the complimentary profiles of one or more gasket material strips. The adhesive can serve to provide an excellent coupling and secure engagement and joint between two gasket material strip ends. It is to be understood that the adhesive can include any of the joint adhesives described herein.

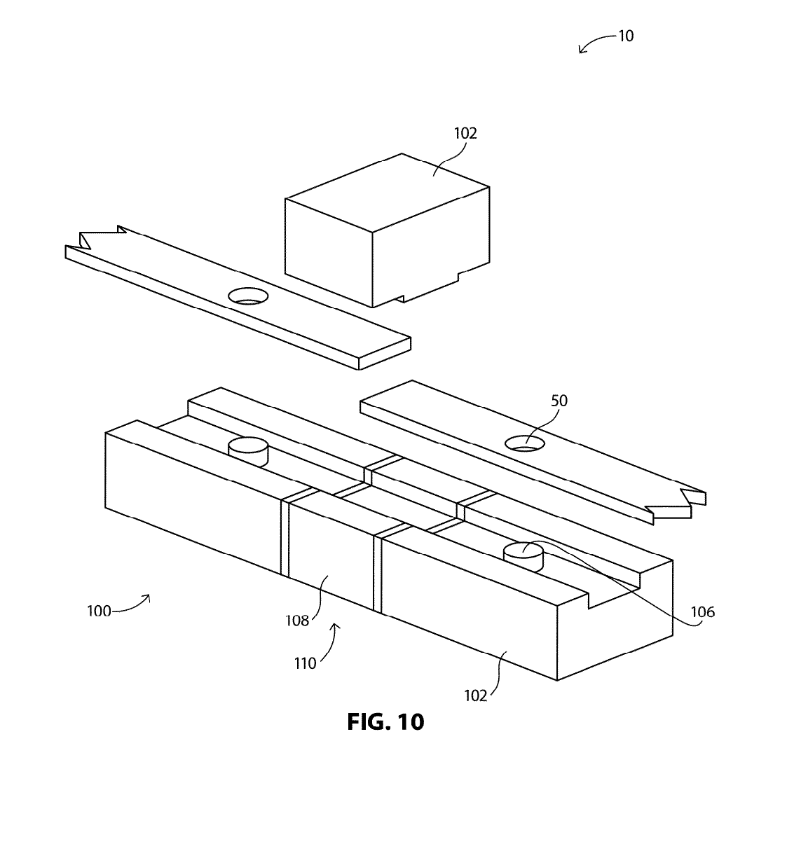

After applying the adhesive, the first and second ends of one or more gasket material strips can be joined. For example, and referring in particular to FIG. 10, the first and second ends can be joined in a splice mold 100.

As illustrated in FIG. 10, the splice mold 100 can include an upper portion 102 and a lower portion 104. The lower portion 104 can have a plurality of alignment structures 106 adapted to engage with complementary alignment structures 50 on the gasket material. The alignment structures 104 can serve to align the gasket material so that a secure and predetermined spacing can be maintained between the first end and the second end of the one or more gasket material strips such that an effective joint can be made.

The splice mold 100 can further include a thermally conductive portion 108, which can be disposed in the joint forming region 110. The joint forming region 110 encompasses the area where the first and second ends meet, and particularly where the adhesive is to be disposed. The thermally conductive portion 108 can allow heat transfer to quickly cure the adhesive disposed between the first and second ends.

In certain embodiments, the method can further include joining a plurality of gasket material strips to form a continuous jointed gasket. For example, one or more gasket material strips can be provided, and each end of the gasket material strip can be jointed to complimentary ends of the other gasket material strips such that a continuous gasket is formed with a plurality of joints between and coupling the gasket material strips. It is to be understood that any number of gasket material strips and corresponding joints can be used as described herein. Accordingly, a large circumference continuous gasket can be formed economically and effectively.

In particular embodiments, the method can further include shaping the complementary first end and/or the second end of the gasket material. For example, the first and second ends can be shaped to create a complimentary profile. As discussed above, in certain embodiments, the first and second ends can be shaped to form a butt shape, a puzzle shape, or any combination thereof. To shape the complimentary profiles, the first and/or second ends can be cut, such as, for example, die cut.

In particular embodiments, the step of contacting the first end of a gasket material and the second end of a gasket material to form a joint can include placing the first end of the gasket material in a splice mold, placing the second end of the gasket material in the splice mold, applying a joint adhesive on the first and/or second ends, and curing the joint adhesive.

In particular embodiments, the gasket material can include a plurality of alignment structures to align and secure the gasket to a housing assembly for installation. In certain embodiments, the splice mold can further include complementary alignment structures which complement the alignment structures disposed on the gasket material. For example, in embodiments wherein the alignment structures include circle shaped apertures, the complementary alignment structures disposed on the splice mold can include cylindrical protrusions. In this way, proper alignment of the first end and the second end can be achieved during formation of the joint.

In further embodiments, the step of forming a gasket material can include providing a sealing layer, and coupling an adhesive layer to the sealing layer. In particular embodiments, the adhesive layer can include a double sided adhesive tape. In other embodiments, the adhesive layer can include a hot-melt adhesive layer.

In still further embodiments, the adhesive layer can further include a release layer, which along with the sealing layer, sandwiches the adhesive layer. The release layer can include a release coating, or can include a release sheet, such as a peel-off sheet.

A particular advantage of certain embodiments of the present disclosure is the unexpected and surprising discovery that a jointed continuous gasket could be formed that exhibited substantially superior sealability rivaling a seamless or jointless molded gasket. The sealability can be quantified by a water tightness and/or dust tightness. For example, IEC 60529:2001 describes the test conditions and setup for determining the water tight performance of a gasketed assembly. In particular, as used herein, the water tight performance can be measured according to IEC 60529:2001, based on section 14.2.7.

Accordingly, in certain embodiments, the gasket according to certain embodiments of the present disclosure can be adapted to exhibit a water tight performance of at least IPX7 as measured according to IEC 60529:2001, a dust tight performance of at least IP6X as measured according to IEC 60529:2001, or combinations thereof as tested after installation in a case. The particular test conditions and setup for determining water tight and dust tight performance is described in detail in the Examples below.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the items as listed below.

Item 1. A roll of gasket material comprising: a precut groove adapted to form a bend in the gasket material during installation of the gasket material, wherein the gasket material is adapted to have a water tight sealability of at least IPX7 as measured according to IEC 60529:2001 when installed in a case.

Item 2. A battery case comprising a continuous gasket material comprising at least one joint and at least one bend groove, wherein the battery case has a water tight sealability of at least IPX7 as measured according to IEC 60529:2001.

Item 3. A gasket comprising a first end and a second end, wherein the first end and the second end are adapted to be coupled together at a joint, wherein the gasket is adapted to have a water tight performance of at least IPX7 as measured according to IEC 60529:2001, a dust tight performance of at least IP6X as measured according to IEC 60529:2001, or combinations thereof as tested after installation in a case.

Item 4. A gasket comprising a plurality of foam strips which are coupled together by at least one joint such that the gasket is continuous, wherein the gasket has a circumference of at least 1 meter, and wherein the gasket comprises an adhesive at the joint.

Item 5. A gasket comprising:
a. a plurality of gasket material strips coupled together at a joint, wherein an adhesive is disposed at the joint; and
b. an adhesive sheet comprising a release sheet disposed adjacent to a major surface of the gasket material strips, such that the adhesive sheet is sandwiched between the gasket material strip and the release sheet.

Item 6. A gasket comprising:
a. a gasket material comprising:
   i. a foam layer;
   ii. an adhesive sheet disposed adjacent to the foam layer;
   iii. a release layer disposed adjacent to the adhesive sheet such that the adhesive sheet is sandwiched between the foam layer and the release sheet; and
b. a bend groove disposed through the gasket material.

Item 7. A gasket comprising:
a. a gasket material comprising:
i. a foam layer;
b. a bend groove disposed through the gasket material;
c. wherein the gasket has an undeformed configuration and a deformed configuration;
d. wherein the bend groove comprises a generally T-shaped groove when the deformable section is in an undeformed configuration, the T-shaped groove having a first side and a second side, opposite the first side, wherein the first side and the second side are arranged to form an angle 180-α when the foam gasket is substantially straight, and wherein the first side and second side of the T-shaped groove are adapted to abut to form a predetermined bending angle α when bent into the deformed configuration.

Item 8. The gasket of any one of the preceding items, wherein the gasket comprises a foam layer.

Item 9. The gasket of any one of the preceding items, wherein the gasket comprises a foam layer comprising a PVC, an EPDM, an epoxy, a polyurethane, a silicone, a thermoplastic elastomer or any combination thereof.

Item 10. The gasket of any one of the preceding items, wherein the gasket comprises a foam layer having an average thickness of at least 0.1 mm, at least 0.3 mm, at least 0.7 mm, or even at least 1 mm.

Item 11. The gasket of any one of the preceding items, wherein the gasket comprises a foam layer having an average thickness of no greater than about 100 mm, no greater than about 75 mm, no greater than about 50 mm, no greater than about 25 mm, or even no greater than about 10 mm.

Item 12. The gasket of any one of the preceding items, wherein the gasket comprises an adhesive layer disposed adjacent a major surface of the foam layer.

Item 13. The gasket of any one of the preceding items, wherein the gasket comprises a double sided adhesive layer disposed adjacent a major surface of the foam layer.

Item 14. The gasket of any one of the preceding items, wherein the gasket comprises a double sided adhesive layer disposed directly adjacent a major surface of the foam layer.

Item 15. The gasket of any one of the preceding items, wherein the gasket comprises a double sided adhesive layer disposed adjacent a major surface of the foam layer, and wherein the gasket further comprises a release sheet disposed adjacent a major surface of the double sided adhesive tape, opposite the foam layer.

Item 16. The gasket of any one of the preceding items, wherein the release layer comprises a release coating, a release sheet, or combinations thereof.

Item 17. The gasket of any one of the preceding items, wherein the release layer comprises a release sheet.

Item 18. The gasket of any one of the preceding items, wherein the gasket comprises a plurality of alignment structures.

Item 19. The gasket of any one of the preceding items, wherein the gasket comprises a plurality of alignment structures adapted to align the gasket within a housing.

Item 20. The gasket of any one of the preceding items, wherein the gasket comprises a plurality of alignment structures adapted to align ends of gasket material in a splice mold such that the ends of gasket material are arranged in a predetermined configuration.

Item 21. The gasket of any one of the preceding items, wherein the gasket comprises a plurality of alignment structures, wherein at least one of the plurality of alignment structures is adapted to align the gasket within a housing, and wherein at least one of the plurality of alignment structures is adapted to align ends of gasket material in a splice mold such that the ends of gasket material are arranged in a predetermined configuration.

Item 22. The gasket of any one of the preceding items, wherein the gasket comprises an alignment structure, wherein the alignment structure is adapted to align the gasket within a housing, and wherein the alignment structure is adapted to align ends of gasket material in a splice mold such that the ends of gasket material are arranged in a predetermined configuration for joining.

Item 23. The gasket of any one of the preceding items, wherein the gasket comprises an alignment structure comprising a groove, an aperture, or combinations thereof.

Item 24. The gasket of any one of the preceding items, wherein the gasket is continuous.

Item 25. The gasket of any one of the preceding items, wherein the gasket is continuous, and wherein the gasket comprises at least 1 joint, at least 2 joints, at least 3 joints, or even at least 4 joints.

Item 26. The gasket of any one of the preceding items, wherein the gasket comprises at least one joint, and wherein two opposing ends of gasket material form a butt joint, a puzzle joint, or combinations thereof.

Item 27. The gasket of any one of the preceding items, wherein the gasket comprises at least one puzzle joint.

Item 28. The gasket of any one of the preceding items, wherein the gasket comprises at least one puzzle joint comprising a first puzzle shaped end and a second puzzle shaped end, and wherein the first and second puzzle shaped ends are generally complementary such that the first end and the second end can be coupled together without the necessity of an adhesive.

Item 29. The gasket of any one of the preceding items, wherein the gasket comprises at least one joint, and wherein adhesive is disposed at the at least one joint.

Item 30. The gasket of any one of the preceding items, wherein the adhesive comprises a silicone adhesive, a urethane adhesive, an epoxy adhesive, an acrylic adhesive, a rubber adhesive, a polyamide adhesive, an EVA adhesive, or combinations thereof. The gasket of any one of the preceding items, wherein the adhesive comprises a thermosetting adhesive.

Item 31. The gasket of any one of the preceding items, wherein the thermosetting adhesive comprises a silicone adhesive.

Item 32. The gasket of any one of the preceding items, wherein the adhesive comprises a thermoplastic adhesive.

Item 33. The gasket of any one of the preceding items, wherein the adhesive comprises a thermoplastic adhesive having a flammability rating of at least HB, or even V0 as measured according to UL-94.

Item 34. The gasket of any one of the preceding items, wherein the adhesive comprises a thermoplastic adhesive comprising a polyamide adhesive.

Item 35. The gasket of any one of the preceding items, wherein the gasket material strip has a length, a width, and a thickness, and wherein the length is greater than the width, and the width is greater than the thickness.

Item 36. The gasket of any one of the preceding items, wherein a ratio of the gasket material strip length to the gasket material strip width is at least 10:1.

Item 37. The gasket of any one of the preceding items, wherein a ratio of the gasket material strip length to the gasket material strip thickness is at least 50:1.

Item 38. The gasket of any one of the preceding items, wherein the gasket has a thickness of at least 0.1 mm, at least 0.3 mm, at least 0.7 mm, or even at least 1 mm.

Item 39. The gasket of any one of the preceding items, wherein the gasket has a thickness of no greater than 500 mm, no greater than 300 mm, no greater than 150 mm, or even no greater than 75 mm.

Item 40. The gasket of any one of the preceding items, wherein the gasket is continuous, and wherein the gasket has a circumference of at least 0.5 meters, at least 1 meter, at least 1.5 meters, or even at least 2 meters.

Item 41. The gasket of any one of the preceding items, wherein the gasket is continuous, and wherein the gasket has a circumference of no greater than 50 meters, no greater than 20 meters, or even no greater than 5 meters.

Item 42. The gasket of any one of the preceding items, wherein the gasket comprises at least one bend groove.

Item 43. The gasket of any one of the preceding items, wherein the gasket comprises a bend groove having:
a. a first surface extending from a first edge of the gasket material towards an opposite edge of the gasket material strip at angle of α₁;
b. a second surface extending from a first edge of the gasket material towards an opposite edge of the gasket material strip at angle of α₂;
c. wherein the first surface and second surface are spaced apart from one another a distance D1, as measured from the intersecting point of the first surface and the first edge to the intersecting point of the second surface and the first edge; and
d. wherein the first surface and second surface generally extend toward each other.

Item 44. The gasket of any one of the preceding items, wherein the first surface and the second surface are adapted to abut when the gasket material strip is bent to the desired shape.

Item 45. The gasket of any one of the preceding items, wherein the bend groove further comprises a third surface extending from the end of the first surface and away from the second surface.

Item 46. The gasket of any one of the preceding items, wherein the third surface has an arcuate profile.

Item 47. The gasket of any one of the preceding items, wherein the bend groove further comprises a fourth surface extending from the end of the second surface and away from the first surface.

Item 48. The gasket of any one of the preceding items, wherein the fourth surface has an arcuate profile.

Item 49. The gasket of any one of the preceding items, wherein the third surface and the fourth surface are generally symmetrical.

Item 50. The gasket of any one of the preceding items, wherein the bend groove further comprises a fifth surface extending between and connecting the third surface and the fourth surface by a distance of D₂.

Item 51. The gasket of any one of the preceding items, wherein the fifth surface extends generally parallel to the outer edge of the gasket strip material.

Item 52. The gasket of any one of the preceding items, wherein the bend groove further comprises a first chamfer and a second chamfer, wherein the first chamfer is disposed between the third surface and the fifth surface, and wherein the second chamfer is disposed between the fourth surface and the fifth surface.

Item 53. The gasket of any one of the preceding items, wherein the first chamfer and the second chamfer can be adapted to form an open buffer space through the gasket material after bent.

Item 54. The gasket of any one of the preceding items, wherein the buffer space has a width of at least about 0.1 mm, at least about 0.5 mm, or even at least about 1 mm.

Item 55. The gasket of any one of the preceding items, wherein the buffer space has a width of no greater than 20 mm, no greater than 15 mm, or even no greater than 10 mm.

Item 56. The gasket of any one of the preceding items, wherein the buffer space has a width in a range of 0.1 mm to 20 mm, or even 1 mm to 10 mm.

Item 57. The gasket of any one of the preceding items, wherein the distance from the end of the third surface to the edge of the gasket strip material is at least 1 mm, at least 2 mm, at least 3 mm, at least 4 mm, or even at least 5 mm.

Item 58. The gasket of any one of the preceding items, wherein the distance from the end of the third surface to the edge of the gasket strip material can be no greater than 25 mm, no greater than 20 mm, no greater than 15 mm, or even no greater than 10 mm.

Item 59. The gasket of any one of the preceding items, wherein the distance from the end of the third surface to the edge of the gasket strip material is in a range of from 1 mm to 25 mm, or even 4 mm to 10 mm.

Item 60. The gasket of any one of the preceding items, wherein the bend groove has a generally “T” shaped profile.

Item 61. The gasket of any one of the preceding items, wherein the first surface and second surface are generally symmetrical such that α₁ and α₂ are within about 10 degrees of each other.

Item 62. The gasket of any one of the preceding items, wherein α₁ and α₂ are within about 70 degrees of each other, within about 60 degrees of each other, or even within about 50 degrees of each other.

Item 63. The gasket of any one of the preceding items, wherein the gasket comprises an asymmetrical bend groove.

Item 64. The gasket of any one of the preceding items, wherein the gasket comprises an asymmetrical bend groove and an alignment structure, and wherein the bend groove has a shortest distance from the alignment structure of at least about 2 mm, or even at least about 3 mm.

Item 65. The gasket of any one of the preceding items, wherein the gasket comprises an asymmetrical bend groove and an alignment structure, and wherein the bend groove has a shortest distance from the alignment structure of no greater than 10 mm, no greater than 8 mm, or even no greater than 6 mm.

Item 66. The gasket of any one of the preceding items, wherein the asymmetrical bend groove has a third surface having a shorter distance than the fourth surface, and wherein the third surface is nearer the alignment structure than the fourth surface.

Item 67. The gasket of any one of the preceding items, wherein the gasket has a degree of protection against water of at least IPX7 as measured according to IEC 60529:2001 based on section 14.2.7.

Item 68. The gasket of any one of the preceding items, wherein the gasket has a dust tight performance of at least IP6X of IEC 60529:2001 based on section 14.2.7

Item 69. A method comprising:
a. providing a first end of a gasket material;
b. providing a second end of a gasket material, wherein the first and second ends have a complimentary profile;
c. applying an adhesive to the first end and/or second end of the gasket material;
d. contacting the first end of a gasket material and the second end of a gasket material to form a joint.

Item 70. A method comprising:
a. providing a gasket sheet material;
b. forming a plurality of gasket material strips from the gasket material sheet, the plurality of gasket material strips each having a first end and a second end opposite the first end;
c. form a first coupling member on the first end of at least one of the plurality of foam strips;
d. forming a second coupling member on the second end;
e. applying an adhesive to the first and/or second coupling members; and
f. joining the first coupling member to the second coupling member to form a jointed gasket.

Item 71. A method of forming a continuous gasket from a plurality of foam strips, the method comprising:
a. providing a first foam strip having a first end and a second end opposite the first end;
b. providing a second foam strip having a first end and a second end opposite the first end;
c. applying an adhesive to the first end and/or the second end of the first foam strip and/or second foam strip;
d. placing the first foam strip and the second foam strip into a splice mold such that an alignment structure disposed on the foam strip and an alignment structure on the splice mold interact to align the first foam strip and the second foam strip in a predetermined alignment.

Item 72. The method of any one of the preceding items, wherein the gasket material sheet comprises a foam layer, an adhesive layer, and a release sheet.

Item 73. The method of any one of the preceding items, wherein the method further comprises forming a gasket sheet material, and wherein forming a gasket sheet material comprises forming a composite comprising a foam layer and a double sided adhesive layer.

Item 74. The method of any one of the preceding items, wherein the method further comprises forming a gasket sheet material, and wherein forming a gasket sheet material comprises forming a composite comprising a foam layer, a double sided adhesive layer, and a release sheet.

Item 75. The method of any one of the preceding items, wherein providing a foam sheet comprises forming a foam sheet.

Item 76. The method of any one of the preceding items, wherein forming a foam sheet comprises casting, skiving, or combinations thereof.

Item 77. The method of any one of the preceding items, wherein forming a plurality of gasket material strips from the gasket sheet material comprises die-cutting the gasket sheet material to form the gasket material strips.

Item 78. The method of any one of the preceding items, wherein the method further includes placing the first foam strip and the second foam strip into a splice mold such that an alignment structure disposed on the foam strip and an alignment structure on the splice mold interact to align the first foam strip and the second foam strip in a predetermined alignment.

Item 79. The method of any one of the preceding items, wherein the method further comprises aligning the first end of a gasket material and the second end of a gasket material within a splice mold.

Item 80. The method of any one of the preceding items, wherein aligning the first end of a gasket material and the second end of a gasket material comprises aligning the first end of a gasket material and the second end of a gasket material such that there is a generally continuous transition from the first end of a gasket material to the second end of a gasket material.

Item 81. The method of any one of the preceding items, wherein the method further comprises providing an adhesive sheet; and contacting the adhesive sheet to the gasket material.

Item 82. The method of any one of the preceding items, wherein the method further comprises providing a double sided adhesive sheet comprising a release sheet; and coupling the adhesive sheet to the gasket material, such that the adhesive sheet is sandwiched between the release sheet and the gasket material.

Item 83. The method of any one of the preceding items, wherein the splice mold comprises a lower mold and an upper mold, and wherein the lower mold is adapted to align the first end and the second end of gasket material strips, and wherein the upper mold is adapted to apply pressure and conduct heat sufficient to cure the adhesive.

Item 84. The method of any one of the preceding items, wherein the lower mold is further adapted to conduct heat towards the joint.

Item 85. The method of any one of the preceding items, wherein the first end of a gasket material and the second end of a gasket material are disposed on two separate pieces of gasket material.

Item 86. The method of any one of the preceding items, wherein the first end of a gasket material and the second end of a gasket material are disposed on opposite ends of a single piece of gasket material.

Item 87. The method of any one of the preceding items, wherein the method comprises forming a continuous gasket material from at least 1, at least 2, at least 3, or even at least 4 separate pieces of gasket material.

Item 88. The method of any one of the preceding items, wherein the method comprises forming complimentary shaped engagement surfaces on the first end of a gasket material and the second end of a gasket material.

Item 89. The method of any one of the preceding items, wherein the method comprises forming complimentary puzzle shaped engagement surfaces on the first end of a gasket material and the second end of a gasket material.

Item 90. The method of any one of the preceding items, wherein method further comprises curing the adhesive.

Item 91. The method of any one of the preceding items, wherein the method further comprises thermally curing the adhesive.

Item 92. The method of any one of the preceding items, wherein the method further comprises thermally curing the adhesive while the first end of a gasket material and the second end of a gasket material are contacting the splice mold.

### EXAMPLES

### Example 1

Dust Protection—To verify the degree of protection that the gasket can provide, the following Dust Protection Test is performed

Test Setup: The test conditions are based on ‘article 13.4 (category 2) and 13.6; (IP6X) of IEC 60529:2001. The laboratory ambience conditions were: a room temperature of 23 degrees Celsius, plus or minus 2 degrees Celsius; a relative humidity of 55%, plus or minus 2%. The test equipment used was a Dust Test Chamber, Model ST 1000 U, available from WEISS. The dust material used was Talcum powder (100% dry fine). The amount of talcum powder used was 2 kg/m3 (chamber volume). The dust flow direction was vertical to achieve slowest possible downward settlement. The test length was 8 hours.

Samples: Each test specimen includes a foam product under the designation SF70 (F20) having 3.2 mm thickness without adhesive and available from Saint-Gobain. The following test specimens were produced to determine the ability of different joint constructions to protect against the penetration of dust.

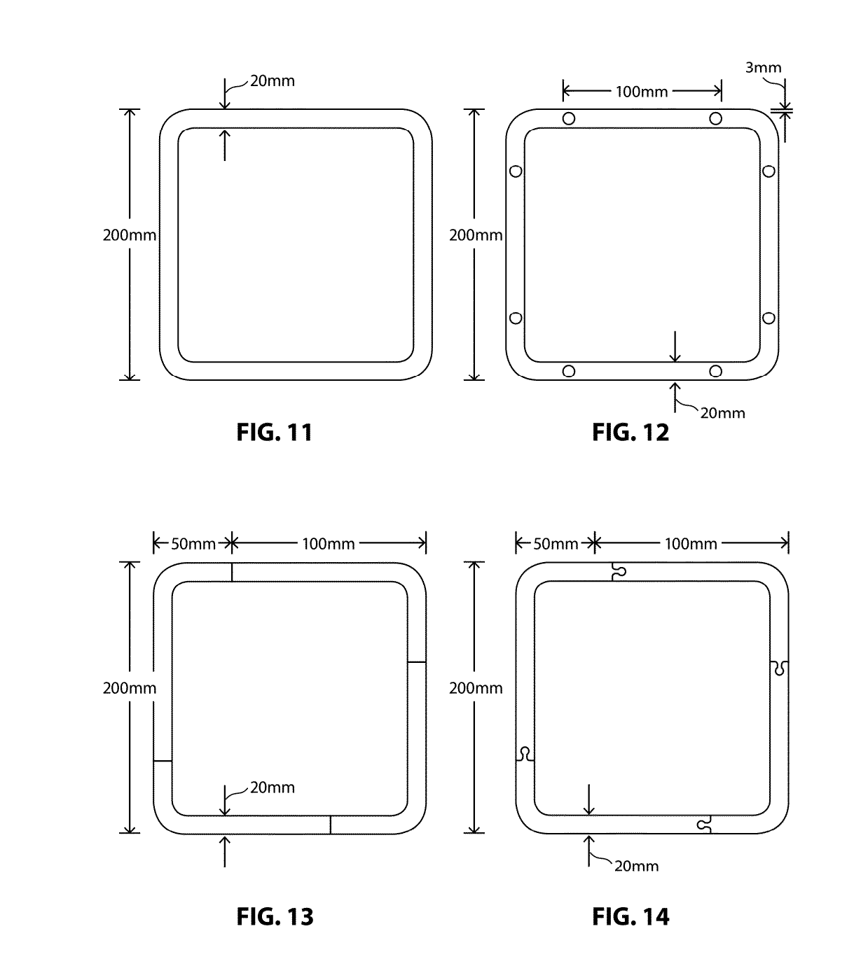

Sample A—Represented in FIG. 11, sample A is a comparative example which includes a seamless specimen that does not have a joint.

Sample B—Represented in FIG. 12, sample B is a comparative example which includes a seamless specimen that does not have a joint, but includes circular shaped alignment structure holes approximately 3 mm from the edge of the gasket.

Sample C—Represented in FIG. 13, sample C includes a puzzle jointed specimen without adhesive at the joints.

Sample D—Represented in FIG. 13, sample D includes a puzzle jointed specimen including Elastosil® E43 RTV silicone adhesive available from WACKER at the puzzle joints.

Sample E—Represented in FIG. 14, sample E includes a butt jointed specimen with Elastosil® E43 RTV silicone adhesive available from WACKER at the butt joints.

Sample F—Represented in FIG. 14, sample F includes a butt jointed specimen with Elastosil®LR 3003/60 A & B heat-cured LSR adhesive at the butt joints.

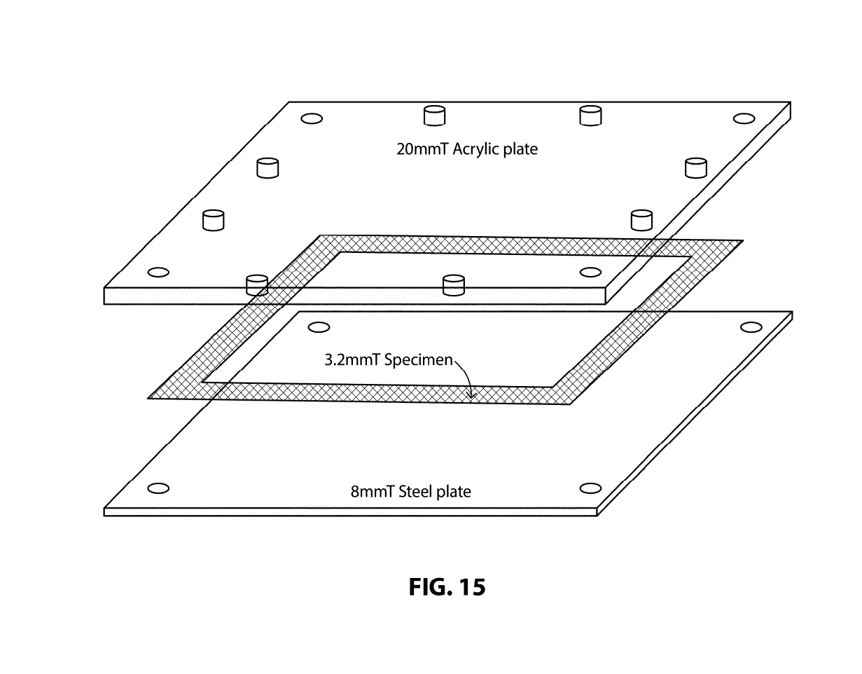

The specimens are then assembled between an acrylic plate and a steel plate as outlined in FIG. 15. The following test procedure is then conducted:
a. Then specimen is conditioned for 24 hours at 23±2° C. RT, 55±2% RH prior to the test.
b. The specimen is placed on the bottom plate (8 mmT Steel plate).
c. The upper plate (20 mmT Acrylic plate) is placed having spacers at each corner to apply 40% compression ratio (1.92 mmT in case of 3.2 mmT Specimen) on the specimen and tighten the plates with bolt screws.
d. The assembly is then fixed on the steel mesh plate inside of the test chamber, and the start button is initiated to operate the chamber.
e. After 2 hours, the assembly is taken out and checked whether deposit of talcum powder is observable or not with the naked eye.

The following results were obtained. A satisfied result indicates that the gasket is rated to the degree of protection of IP6X against solid foreign objection based on the definition of Table 2 in IEC 60529:2001. Each sample was tested twice, and had to pass both times to be indicated as Satisfied.

| Sample | Result |
|---|---|
| A | Satisfied |
| B | Satisfied |
| C | Not Satisfied |
| D | Satisfied |
| E | Satisfied |
| F | Satisfied |

### Example 2

Example 2 tests the degree of protection against dust for a jointed gasket in comparison seamless or jointless samples using different types of foam cores. The same test conditions and test procedure outlined in Example 1 was used. The various samples were are as follows:

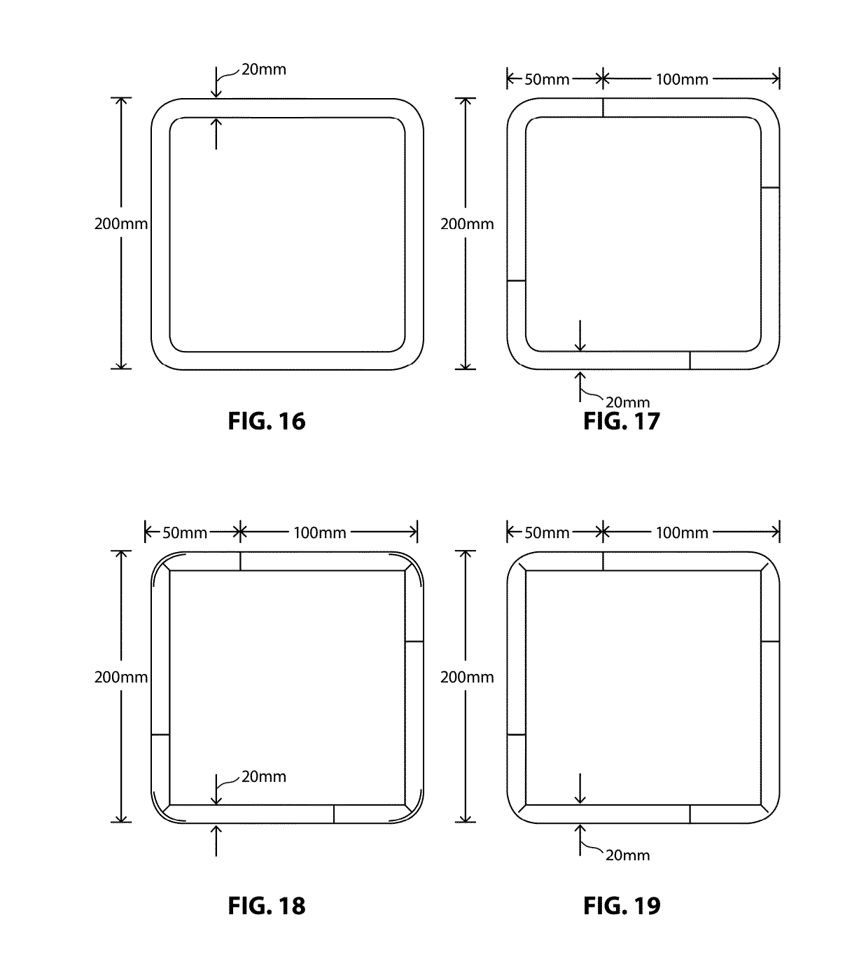

Sample 2A—Represented in FIG. 16, Sample 2A is a comparative example including a seamless specimen of a PVC foam gasket materialunder the trade designation V764LCS, available from Saint-Gobain.

Sample 2B—Represented in FIG. 17, Sample 2B includes a butt jointed specimen including a PVC foam gasket material under the trade designation V764LCS, available from Saint-Gobain and ‘SIKAFLEX-11FC polyurethane adhesive available from SIKA disposed at the butt joints.

Sample 2C—Represented in FIG. 16, Sample 2C is a comparative example including a seamless specimen of PF 45 PUR foam available from Saint-Gobain.

Sample 2D—Represented in FIG. 16, Sample 2D is a comparative example including a seamless specimen of AGP200 PUR foam available from Saint-Gobain.

Sample 2E—Represented in FIG. 16, Sample 2E is a comparative example including a seamless specimen of JEP-2015 EPDM foam available from JI Korea.

Sample 2F—Represented in FIG. 16, Sample 2F is a comparative example including a seamless specimen of SF70 silicone foam available from Saint-Gobain.

The following results were obtained:

| Sample | Result |
|---|---|
| 2A | Satisfied |
| 2B | Satisfied |
| 2C | Not Satisfied |
| 2D | Not Satisfied |
| 2E | Satisfied |
| 2F | Satisfied |

### Example 3

Example 3 is a comparison of a V-groove groove for bend formation and a T-shaped groove for bend formation according to embodiments of the present disclosure. For each sample, the core used was SF70(F20) silicone foam available from Saint-Gobain having a 3.2 mm thickness without adhesive. Each specimen used a butt-joints and include SIKAFLEX-11FC RTV silicone adhesive available from SIKA at the joints.

The test specimens are as follows:

Sample 3A—Sample 3A—represented in FIG. 18, Sample 3A includes T-shaped grooves at the bends.

Sample 3B—Represented in FIG. 19, Sample 3B includes a V-groove groove at the bends.

The same test conditions and test procedures were used in Example 3 as outlined in Example 1 above to determine the degree of dust protection. The following results were obtained.

| Sample | Result |
|---|---|
| 3A | Satisfied |
| 3B | Not Satisfied |

### Example 4

Example 4 is a comparison of water sealing and absorption properties of various samples.

Sample 4A is a sample including a butyl coated PVC foam extrusion.

Sample 4B is a sample including foam-in-place thermoset gasketing material.

Sample 4C is a sample including a form-in-place gasketing material comprising expanded PTFE.

Sample 4D is a sample including a semi-closed EPDM foam.

Sample 4E is a sample including a semi-closed EPDM foam.

Sample 4F is a sample including a foamed thermoplastic elastomer extrusion.

Sample 4G is a sample including a foamed thermoplastic elastomer extrusion.

Sample 4H is a sample including a modified cellular silicone foam rubber.

Sample 4I is a sample including a medium density closed-cell silicone foam rubber.

Sample 4J is a sample including a micro-cellular polyurethane foam.

Sample 4K is a sample including a low-density, closed-cell PVC foam.

Sample 4L is a sample including a high-density, closed-cell PVC foam.

Sample 4M is a sample including a room temperature vulcanization (RTV) silicone rubber.

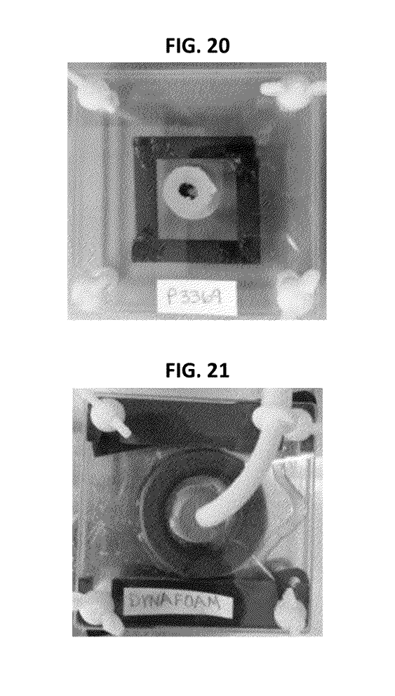

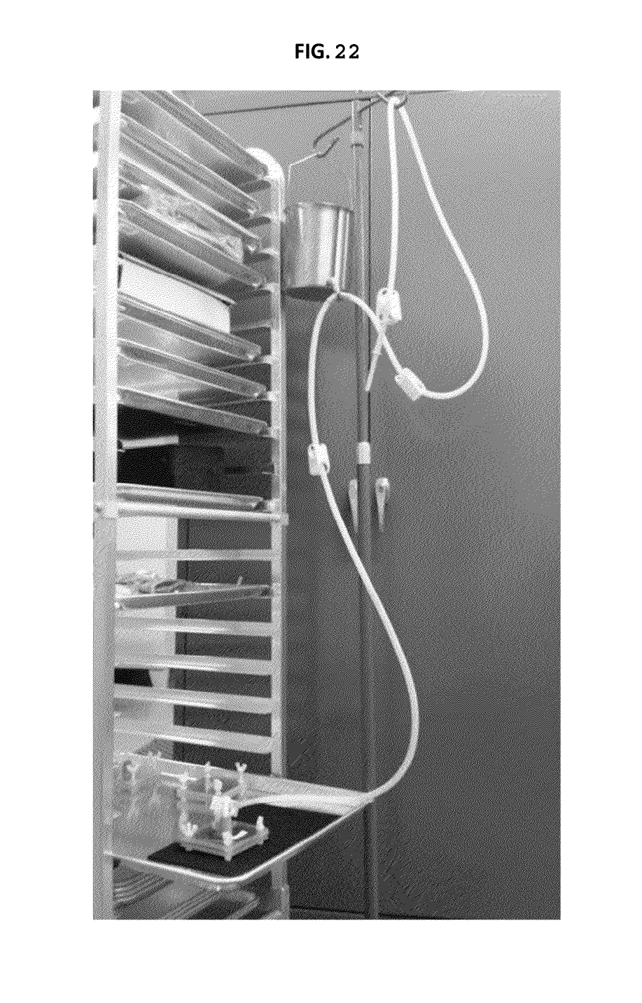

The samples were tested in linear (square) formation (see FIG. 20) and O-ring formation (see FIG. 21). The results were identical for each configuration. Each O-ring sample was sized to have an outer diameter of about 51 mm and a width of about 5 mm. The samples are then assembled in a water sealing testing apparatus as pictured in FIG. 22.

Each sample was Samples were compressed 30%, 50%, 70%±10% from original height.

Each sample was tested with 1 m head of water for 30 minutes. After 30 minutes, the sample is observed for water leakage and water absorption observable with the naked eye.

If samples received a PASS at low compression they were not tested at higher compression.

The following results were obtained:

| Sample | Compression | Water Leakage | Water Absorption |
|---|---|---|---|
| 4A | 30% | PASS | PASS |
| 4B | 30% | FAIL | FAIL |
| 4B | 50% | PASS | PASS |
| 4C | 30% | FAIL | FAIL |
| 4C | 50% | FAIL | FAIL |
| 4C | 70% | FAIL | FAIL |
| 4D | 30% | FAIL | FAIL |
| 4D | 50% | FAIL | FAIL |
| 4D | 70% | FAIL | FAIL |
| 4E | 30% | FAIL | FAIL |
| 4E | 50% | FAIL | FAIL |
| 4E | 70% | FAIL | FAIL |
| 4F | 30% | FAIL | FAIL |
| 4F | 50% | FAIL | FAIL |
| 4F | 70% | PASS | FAIL |
| 4G | 30% | FAIL | FAIL |
| 4G | 50% | FAIL | FAIL |
| 4G | 70% | FAIL | FAIL |
| 4H | 30% | FAIL | FAIL |
| 4H | 50% | FAIL | FAIL |
| 4H | 70% | FAIL | FAIL |
| 4I | 30% | PASS | PASS |
| 4J | 30% | FAIL | FAIL |
| 4J | 50% | FAIL | FAIL |
| 4J | 70% | FAIL | FAIL |
| 4K | 30% | FAIL | FAIL |
| 4K | 50% | FAIL | FAIL |
| 4K | 70% | FAIL | FAIL |
| 4L | 30% | PASS | FAIL |
| 4M | 30% | PASS | PASS |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A gasket comprising:
a. a gasket material comprising:
i. a foam layer;
ii. an adhesive sheet disposed adjacent to the foam layer;
iii. a release layer disposed adjacent to the adhesive sheet such that the adhesive sheet is sandwiched between the foam layer and the release sheet; and
b. a bend groove disposed through the gasket material.

2. The gasket of claim 1, wherein the foam layer comprises a PVC, an EPDM, an epoxy, a polyurethane, a silicone, a thermoplastic elastomer or any combination thereof.

3. The gasket of claim 1, wherein the foam layer has an average thickness of at least 0.1 mm.

4. The gasket of claim 1, wherein the foam layer has an average thickness of no greater than about 100 mm.

5. The gasket of claim 1, wherein the adhesive sheet comprises a double sided adhesive sheet disposed directly adjacent a major surface of the foam layer.

6. The gasket of claim 1, wherein the gasket comprises an alignment structure comprising a groove, an aperture, or combinations thereof, adapted to align ends of gasket material in a splice mold such that the ends of gasket material are arranged in a predetermined configuration.

7. The gasket of claim 1, wherein the gasket comprises an alignment structure comprising a groove, an aperture, or combinations thereof, wherein the alignment structure is adapted to align the gasket within a housing, and wherein the alignment structure is adapted to align ends of gasket material in a splice mold such that the ends of gasket material are arranged in a predetermined configuration for joining.

8. The gasket of claim 1, wherein the gasket comprises at least one joint, and wherein two opposing ends of gasket material form a butt joint, a puzzle joint, or combinations thereof.

9. The gasket of claim 1, wherein the gasket comprises at least one puzzle joint.

10. The gasket of claim 9, wherein the at least one puzzle joint comprises a first puzzle shaped end and a second puzzle shaped end, and wherein the first and second puzzle shaped ends are generally complementary such that the first end and the second end can be coupled together without the necessity of an adhesive.

11. The gasket of claim 1, wherein the gasket is continuous, and wherein the gasket has a circumference of at least 0.5 meters.

12. The gasket of claim 1, wherein the gasket comprises a bend groove having:
a. a first surface extending from a first edge of the gasket material towards an opposite edge of the gasket material strip at angle of α₁;
b. a second surface extending from a first edge of the gasket material towards an opposite edge of the gasket material strip at angle of α₂;
c. wherein the first surface and second surface are spaced apart from one another a distance D1, as measured from the intersecting point of the first surface and the first edge to the intersecting point of the second surface and the first edge; and
d. wherein the first surface and second surface generally extend toward each other.

13. The gasket of claim 12, wherein the first surface and second surface are generally symmetrical such that α₁ and α₂ are within about 10 degrees of each other.

14. The gasket of claim 1, wherein the bend groove has a generally “T” shaped profile.

15. The gasket of claim 1, wherein the gasket has a degree of protection against water of at least IPX7 as measured according to IEC 60529:2001 based on section 14.2.7.

16. The gasket of claim 1, wherein the gasket has a dust tight performance of at least IP6X of IEC 60529:2001 based on section 14.2.7

17. A gasket comprising:
a. a gasket material comprising:
i. a foam layer;
b. a bend groove disposed through the gasket material;
c. wherein the gasket has an undeformed configuration and a deformed configuration;
d. wherein the bend groove comprises a generally T-shaped groove when the deformable section is in an undeformed configuration, the T-shaped groove having a first side and a second side, opposite the first side, wherein the first side and the second side are arranged to form an angle 180-α when the foam gasket is substantially straight, and wherein the first side and second side of the T-shaped groove are adapted to abut to form a predetermined bending angle α when bent into the deformed configuration.

18. A gasket comprising a plurality of foam strips which are coupled together by at least one joint such that the gasket is continuous, wherein the gasket has a circumference of at least 1 meter, and wherein the gasket comprises an adhesive at the joint.

19. The gasket of claim 18, wherein the foam layer comprises a PVC, an EPDM, an epoxy, a polyurethane, a silicone, a thermoplastic elastomer or any combination thereof.

20. The gasket of claim 19, wherein the gasket is adapted to have a water tight performance of at least IPX7 as measured according to IEC 60529:2001, a dust tight performance of at least IP6X as measured according to IEC 60529:2001, or combinations thereof as tested after installation in a case.
